(19) United States
(12) Patent Application Publication
(10) Pub. No.: US 2026/0062568 A1
(43) Pub. Date: Mar. 5, 2026

(54) COMPOSITIONS AND METHODS FOR CLEANING AND STRIPPING

(71) Applicant: AdvanSix Resins & Chemicals LLC, Parsippany, NJ (US)

(72) Inventors: Edward Asirvatham, Chatham, NJ (US); Karttikay Moudgil, Johns Creek, GA (US)

(21) Appl. No.: 19/384,235

(22) Filed: Nov. 10, 2025

Related U.S. Application Data
(63) Continuation of application No. 16/982,273, now abandoned.
(60) Provisional application No. 62/650,363, filed on Mar. 30, 2018.

(51) Int. Cl. C09D 9/00; C09D 9/04; C11D 3/43; C11D 7/50

(52) U.S. Cl. CPC C09D 9/005; C11D 3/43; C11D 7/5013; C09D 9/04

(57) ABSTRACT

The present disclosure provides a composition for cleaning or stripping a material from a substrate. The composition includes a primary solvent and a co-solvent. The co-solvent includes one or more caprolactam-derived solvents.

### CROSS REFERENCE TO RELATED APPLICATIONS

This application is a continuation application of U.S. patent application Ser. No. 16/982,273, filed Sep. 18, 2020, which is a U.S. 371 application of PCT application no. PCT/US2019/024302, filed Mar. 27, 2019, which claims the benefit of U.S. Provisional Patent Application Ser. No. 62/650,363, filed Mar. 30, 2018, the disclosures of which are incorporated by reference herein in their entireties.

### FIELD

The present disclosure relates to compositions and methods for cleaning materials from substrates. In particular, the disclosure relates to compositions and methods for cleaning or stripping paints, inks, and resins from substrates.

### BACKGROUND

Cleaning compositions are widely used to remove paints, inks, and polymer resins from a variety of substrates. For example, cleaning compositions are used to strip cured paint from substrates, clean wet, or partially cured paint from painting equipment, clean ink from rollers in lithographic printing, and clean polymer resin from polymer resin processing equipment.

In some cases, the one or more solvents include N-methyl-2-pyrrolidone (NMP). NMP is an excellent solvent for many of the most difficult to dissolve materials. However, NMP has been found to be a reproductive toxin. According to an EPA assessment of potential risks to people, acute and chronic risks identified for people who use NMP for less than 4 hours per day could be reduced by use of appropriate chemical resistance gloves. However, gloves and respirators do not adequately reduce risks to people who use NMP for more than four hours per day on a single day or repeatedly over a succession of days. What is needed is a solvent that dissolves paint, ink, and resins that is neither a reproductive toxin nor a suspected carcinogen or mutagen.

### SUMMARY

The present disclosure provides a composition for cleaning or stripping a material from a substrate. The composition includes a primary solvent and a co-solvent. The co-solvent includes one or more caprolactam-derived solvents according to the general formula:

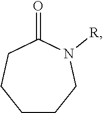

in which R is a linear alkyl group of 1, 2 or 4 unsubstituted carbons.

In one form thereof, the present disclosure provides a composition including a primary solvent and a co-solvent. The co-solvent includes one or more caprolactam-derived solvents. The caprolactam-derived solvents are according to the general formula:

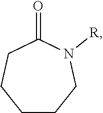

in which R is a linear alkyl group of 1, 2 or 4 unsubstituted carbons.

A concentration of the co-solvent in the composition may be from 5 wt. %-49 wt. % of the composition. The one or more caprolactam-derived solvents in the composition may include at least one of: N-methylcaprolactam, N-ethylcaprolactam, and N-butylcaprolactam. The one or more caprolactam-derived solvents in the composition may include two caprolactam-derived solvents. Each of the two caprolactam-derived solvents in the composition may be from 5 wt. %-95 wt. % of the co-solvent. The two caprolactam-derived solvents in the composition may be N-methylcaprolactam and N-ethylcaprolactam. Alternatively, the two caprolactam-derived solvents in the composition may be N-methylcaprolactam and N-butylcaprolactam. Alternatively, the two caprolactam-derived solvents in the composition may be N-ethylcaprolactam and N-butylcaprolactam.

The caprolactam-derived solvents in the composition may further include a third caprolactam-derived solvent. Each of the three caprolactam-derived solvents in the composition may be from 5 wt. %-90 wt. % of the co-solvent. The three caprolactam-derived solvents in the composition may be N-methylcaprolactam, N-ethylcaprolactam, and N-butylcaprolactam. The composition may further include a surfactant. The composition may further include a thickening agent.

In another form thereof, the present disclosure provides a method of cleaning a material from a substrate. The method includes applying a composition to the material on the substrate for a period of time to dissolve at least some of the material and then removing the composition including the dissolved material from the substrate, composition including a primary solvent and a co-solvent. The co-solvent includes one or more caprolactam-derived solvents according to the general formula:

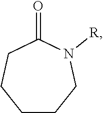

in which R is a linear alkyl group of 1, 2 or 4 unsubstituted carbons.

The one or more caprolactam-derived solvents of the method may include at least one of: N-methylcaprolactam, N-ethylcaprolactam, and N-butylcaprolactam. The one or more caprolactam-derived solvents of the method may include at least two of: N-methylcaprolactam, N-ethylcaprolactam, and N-butylcaprolactam. The composition of the method may further include at least one of: a surfactant and a thickening agent. The material of the method may include a paint, an ink, and/or a polymer resin.

The above mentioned and other features of the invention, and the manner of attaining them, will become more apparent and the invention itself will be better understood by reference to the following description.

### DETAILED DESCRIPTION

The present disclosure provides for compositions for cleaning or stripping a material from a substrate in which caprolactam-derived solvents replace NMP in the compositions. The basis of the caprolactam-derived solvents, caprolactam, has not been found to be, and is not expected to be, either a reproductive toxin or a carcinogen. In particular, N-methylcaprolactam is not considered to be either a reproductive toxin or a carcinogen. Thus, the caprolactam-derived solvents, such as N-methylcaprolactam, N-ethylcaprolactam, and N-butylcaprolactam, are significantly safer solvents than NMP. Caprolactam-derived solvents have surprisingly been found to be as effective as NMP in dissolving many materials.

The present disclosure provides for a composition including a primary solvent and a co-solvent. The co-solvent can include one or more caprolactam-derived solvents. The caprolactam-derived solvents can be according to the general formula:

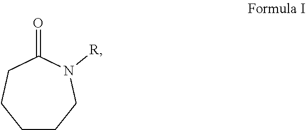

in which R is a linear, alkyl group of 1, 2 or 4 unsubstituted carbons. For example, if R is a methyl group (—CH₃) then the caprolactam-derived solvent is N-methylcaprolactam according to Formula II:

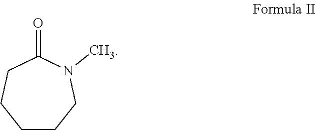

If R is an ethyl group (—CH₂CH₃), then the caprolactam-derived solvent is N-ethylcaprolactam according to Formula III:

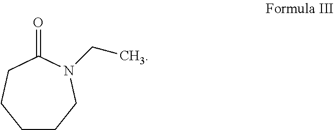

If R is a butyl group (—CH₂CH₂CH₂CH₃), then the caprolactam-derived solvent is N-butylcaprolactam according to Formula IV:

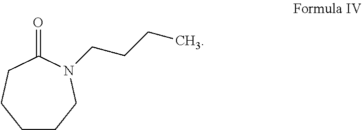 [SMILES: CCCCN1CCCCCC1=O]

The co-solvent can include N-methylcaprolactam, N-ethylcaprolactam, and/or N-butylcaprolactam. The co-solvent can consist of any one of the caprolactam-derived solvents as described above.

The co-solvent may include two of the caprolactam-derived solvents. For example, the co-solvent can include N-methylcaprolactam and N-ethylcaprolactam. Alternatively, the co-solvent can include N-methylcaprolactam and N-butylcaprolactam. Alternatively, the co-solvent can include N-ethylcaprolactam and N-butylcaprolactam. The co-solvent can consist of two of the caprolactam-derived solvents as described above.

In compositions in which the co-solvent includes two of the caprolactam-derived solvents, each of the caprolactam-derived solvents can be as little as 5 weight percent (wt. %), 6 wt. %, 8 wt. %, 10 wt. %, 15 wt. %, 20 wt. %, 25 wt. %, 30 wt. %, 33 wt. %, 35 wt. %, 40 wt. %, 45 wt. %, or 49 wt. %, or as great as 51 wt. %, 55 wt. %, 60 wt. %, 65 wt. %, 67 wt. %, 70 wt. %, 75 wt. %, 80 wt. %, 85 wt. %, 90 wt. %, 92 wt. %, 94 wt. %, or 95 wt. % of the total weight of the co-solvent, or may be within any range defined between any two of the foregoing values, such as, 5 wt. % to 95 wt. %, 6 wt. % to 94 wt. %, 8 wt. % to 92 wt. %, 10 wt. % to 90 wt. %, 15 wt. % to 85 wt. %, 20 wt. % to 80 wt. %, 25 wt. % to 75 wt. %, 30 wt. % to 70 wt. %, 33 wt. % to 67 wt. %, 35 wt. % to 65 wt. %, 40 wt. % to 60, 45 wt. % to 55 wt. %, wt. %, or 49 wt. % to 51 wt. %, for example.

In compositions in which the co-solvent includes N-methylcaprolactam and N-ethylcaprolactam, each of the caprolactam-derived solvents can be as little as 5 weight percent (wt. %), 6 wt. %, 8 wt. %, 10 wt. %, 15 wt. %, 20 wt. %, 25 wt. %, 30 wt. %, 33 wt. %, 35 wt. %, 40 wt. %, 45 wt. %, or 49 wt. %, or as great as 51 wt. %, 55 wt. %, 60 wt. %, 65 wt. %, 67 wt. %, 70 wt. %, 75 wt. %, 80 wt. %, 85 wt. %, 90 wt. %, 92 wt. %, 94 wt. %, or 95 wt. % of the total weight of the co-solvent, or may be within any range defined between any two of the foregoing values, such as, 5 wt. % to 95 wt. %, 6 wt. % to 94 wt. %, 8 wt. % to 92 wt. %, 10 wt. % to 90 wt. %, 15 wt. % to 85 wt. %, 20 wt. % to 80 wt. %, 25 wt. % to 75 wt. %, 30 wt. % to 70 wt. %, 33 wt. % to 67 wt. %, 35 wt. % to 65 wt. %, 40 wt. % to 60, 45 wt. % to 55 wt. %, wt. %, or 49 wt. % to 51 wt. %, for example.

In compositions in which the co-solvent includes N-methylcaprolactam and N-butylcaprolactam, each of the caprolactam-derived solvents can be as little as 5 weight percent (wt. %), 6 wt. %, 8 wt. %, 10 wt. %, 15 wt. %, 20 wt. %, 25 wt. %, 30 wt. %, 33 wt. %, 35 wt. %, 40 wt. %, 45 wt. %, or 49 wt. %, or as great as 51 wt. %, 55 wt. %, 60 wt. %, 65 wt. %, 67 wt. %, 70 wt. %, 75 wt. %, 80 wt. %, 85 wt. %, 90 wt. %, 92 wt. %, 94 wt. %, or 95 wt. % of the total weight of the co-solvent, or may be within any range defined between any two of the foregoing values, such as, 5 wt. % to 95 wt. %, 6 wt. % to 94 wt. %, 8 wt. % to 92 wt. %, 10 wt. % to 90 wt. %, 15 wt. % to 85 wt. %, 20 wt. % to 80 wt. %, 25 wt. % to 75 wt. %, 30 wt. % to 70 wt. %, 33 wt. % to 67 wt. %, 35 wt. % to 65 wt. %, 40 wt. % to 60, 45 wt. % to 55 wt. %, wt. %, or 49 wt. % to 51 wt. %, for example.

In compositions in which the co-solvent includes N-ethylcaprolactam and N-butylcaprolactam, each of the caprolactam-derived solvents can be as little as 5 weight percent (wt. %), 6 wt. %, 8 wt. %, 10 wt. %, 15 wt. %, 20 wt. %, 25 wt. %, 30 wt. %, 33 wt. %, 35 wt. %, 40 wt. %, 45 wt. %, or 49 wt. %, or as great as 51 wt. %, 55 wt. %, 60 wt. %, 65 wt. %, 67 wt. %, 70 wt. %, 75 wt. %, 80 wt. %, 85 wt. %, 90 wt. %, 92 wt. %, 94 wt. %, or 95 wt. % of the total weight of the co-solvent, or may be within any range defined between any two of the foregoing values, such as, 5 wt. % to 95 wt. %, 6 wt. % to 94 wt. %, 8 wt. % to 92 wt. %, 10 wt. % to 90 wt. %, 15 wt. % to 85 wt. %, 20 wt. % to 80 wt. %, 25 wt. % to 75 wt. %, 30 wt. % to 70 wt. %, 33 wt. % to 67 wt. %, 35 wt. % to 65 wt. %, 40 wt. % to 60, 45 wt. % to 55 wt. %, wt. %, or 49 wt. % to 51 wt. %, for example.

The co-solvent can include three of the caprolactam-derived solvents. In compositions in which the co-solvent includes three of the caprolactam-derived solvents, the co-solvent can include N-methylcaprolactam, N-ethylcaprolactam, and N-butylcaprolactam. The co-solvent can consist of three of the caprolactam-derived solvents as described above.

In compositions in which the co-solvent includes three of the caprolactam-derived solvents, each of the caprolactam-derived solvents can be as little as 5 wt. %, 6 wt. %, 8 wt. %, 10 wt. %, 15 wt. %, 20 wt. %, 25 wt. %, 30 wt. %, 33 wt. %, 35 wt. %, 40 wt. %, 45 wt. %, or 49 wt. %, or as great as 50 wt. %, 55 wt. %, 60 wt. %, 65 wt. %, 67 wt. %, 70 wt. %, 75 wt. %, 80 wt. %, 84 wt. %, 88 wt. %, or 90 wt. % of the total weight of the co-solvent, or within any range defined between any two of the foregoing values, such as, 5 wt. % to 90 wt. %, t wt. % to 88 wt. %, 8 wt. % to 84 wt. %, 10 wt. % to 80 wt. %, 15 wt. % to 70 wt. %, 20 wt. % to 60 wt. %, or 25 wt. % to 50 wt. %, for example.

The primary solvent can include an aromatic hydrocarbon solvent, an aliphatic hydrocarbon solvent, water, or any combination thereof. Such solvents can be less expensive than the caprolactam-derived solvents and thus lower the overall cost of the composition. The primary solvent can include alkyl lactates, esters, such as butyl propionate, lactones such as γ-butyrolactone, dioxolanes, glycols, glycol ethers, glycol ether acetates, ether esters such as ethyl-3 ethoxy propionate, dialkyl carbonates, alkylene carbonates, alkoxyalcohols, and diabasic esters, such as dimethyl esters of adipic, glutaric, and succinic acids, ketones, such as cyclohexanone, water, or any combination thereof.

A concentration of the co-solvent in the composition can be as little as 5 wt. %, 6 wt. %, 8 wt. %, 10 wt. %, 15 wt. %, 20 wt. %, 25 wt. %, or as great as 30 wt. %, 33 wt. %, 35 wt. %, 40 wt. %, 45 wt. %, or 49 wt. % of the total weight of the composition, or may be within any range defined between any two of the foregoing values, such as 5 wt. % to 49 wt. %, 6 wt. % to 45 wt. %, 8 wt. % to 40 wt. %, 10 wt. % to 35 wt. %, 20 wt. % to 30 wt. %, or 25 wt. % to 33 wt. %, for example.

Cleaning a material from a substrate can include contacting the material on the substrate with any of the compositions as described above for a period of time, and then removing the composition including at least some of the dissolved material from the substrate. Some of the material not dissolved by the composition may also be removed because the composition has dissolved a portion of the material bonding the undissolved material to the substrate.

The composition can further include a surfactant. The surfactant can provide for improved wetting of the material to be dissolved by the composition. The surfactant can include ethoxylated glycerin/fatty acid esters such as ethoxylated glyceryl fatty acid esters (e.g., PEG 20 glyceryl laurate, PEG 20 glyceryl oleate, PEG 20 glyceryl oleoricinoleate, and PEG 20 glyceryl stearate), sorbitan esters and ethoxylated sorbitan esters (e.g., sorbitan monolaurate and sorbitan trioleate), glycerol monooleate, glycerol dioleate, PEG alkoxylated block polymers, alkoxylated alcohols, alkoxylated alkylphenols, alkoxylated amines, alkoxylated amides, alkoxylated fatty esters, alkoxylated oils, fatty esters, alkoxylated fatty acids, sorbitan derivatives, alkylaryl sulfonates, alkylaryl sulfonic acids, carboxylated alcohol ethoxylates, alkylphenol ethoxylates, carboxylic acids, diphenyl sulfonate derivatives, olefin sulfonates, phosphate esters, phosphorous organic derivatives, anionic surfactants (e.g., sodium lauryl sulfate), and quaternary surfactants, or any combination thereof.

The surfactant can be as little as 0.1 wt. %, 0.2 wt. %, 0.4 wt. %, 0.6 wt. %, 0.8 wt. %, or 1.0 wt. %, or as great as 1.2 wt. %, 1.4 wt. %, 1.6 wt. %, 1.8 wt. %, or 2.0 wt. % of the total weight of the composition, or may be within any range defined between any two of the foregoing values, such as, 0.1 wt. % to 2.0 wt. %, 0.2 wt. % to 1.8 wt. %, 0.4 wt. % to 1.6 wt. %, 0.6 wt. % to 1.4 wt. %, or 0.8 wt. % to 1.2 wt. %, for example.

The composition can further include a thickening agent. The thickening agent can provide the composition with sufficient viscosity to be able to cling to non-horizontal substrates. This can permit the composition to remain in contact with, for example, a vertical painted substrate for a time sufficient for the composition to break down and dissolve at least some the paint and enable removal of the paint from the underlying substrate. The thickener can include organoclays, fatty acid salts, fumed silica, paraffinic waxes, and alkylated, esterified, and oxyalkylated cellulose derivatives, such as ethyl cellulose, cellulose acetate butyrate, hydroxypropyl methyl cellulose, and methyl cellulose, or combinations thereof.

The thickening agent can be as little as 0.1 wt. %, 0.2 wt. %, 0.4 wt. %, 0.6 wt. %, 0.8 wt. %, or 1.0 wt. %, or as great as 1.2 wt. %, 1.4 wt. %, 1.6 wt. %, 1.8 wt. %, or 2.0 wt. % of the total weight of the composition, or may be within any range defined between any two of the foregoing values, such as, 0.1 wt. % to 2.0 wt. %, 0.2 wt. % to 1.8 wt. %, 0.4 wt. % to 1.6 wt. %, 0.6 wt. % to 1.4 wt. %, or 0.8 wt. % to 1.2 wt. %, for example.

The composition may further include additives such as activators and corrosion inhibitors, or neutralizers. The activators can chemically attack organics in the material and enhance the performance of the composition. The neutralizers can prevent corrosion of the substrate due to the corrosive nature of some activators or surfactants.

Any of the compositions described above can be applied to a substrate to clean or strip a material from the substrate. Materials to be cleaned or stripped from the substrate can include, without limitation, paints (cured, partially cured, or uncured), inks such as flexographic and gravure inks, coatings such as acrylic and alkyd coatings, and polymer resins such polyester resins. The composition can be applied to the substrate by, for example, spraying, brushing, or pouring. Substrates can be formed of metals, wood, or polymers.

As used herein, the phrase “within any range defined between any two of the preceding values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

While this invention has been described as relative to exemplary designs, the present invention may be further modified within the spirit and scope of this disclosure. Further, this application is intended to cover such departures from the present disclosure as come within known or customary practice in the art to which this invention pertains.

### EXAMPLES

The Examples below demonstrate the effectiveness of compositions including a co-solvent including one or more caprolactam-derived solvents and methods for cleaning or stripping a material from a substrate using such solvents, according to this disclosure. The compositions are evaluated against commercially available cleaning or stripping products, as well as against compositions using N-methyl pyrrolidone as a co-solvent instead of one or more caprolactam-derived solvents.

### Preparation of Coated Substrates

The various compositions and cleaning stripping or products (collectively “paint strippers”) were tested against up to five coatings, on wood substrates, metal substrates, or both. The wood substrates were pine panels prepared by sanding with 240 grit. The metal substrates were cold-rolled steel panels pretreated with zinc phosphate. The substrates were cleaned to remove debris, dirt, dust, or grease.

The five coatings were: a solvent-borne alkyd paint (SB Alkyd), a solvent-borne 2K epoxy (SB 2K Epoxy), a water-borne 2K epoxy (WB 2K Epoxy), a water-borne acrylic architectural paint (WB Acrylic) and a water-borne polyurethane dispersion industrial coating (WB PUD).

The coatings were applied to the substrates per ASTM D6189 using a high-volume, low pressure (HVLP) spray gun. The coatings were applied to each substrate in three layers, with the second layer tinted differently than the first and third layers so that the efficacy of the paint strippers could be determined at different layers of coating. Each layer was applied to a thickness of about 2 to 2.5 mils, dry film thickness for a total coating thickness of about 6 to 7.5 mils, dry film thickness.

### Paint Stripping Formulations

The caprolactam-derived co-solvents N-methyl caprolactam, N-ethyl caprolactam, and N-butyl caprolactam were incorporated into various paint stripper formulations. N-methyl pyrrolidone was also incorporated into various paint stripper formulations. The formulations were based on butyl propionate and ethyl-3-ethoxy propionate solvents (Formulation 1) or acetone, 1,3-dioxolane, and propylene carbonate solvents (Formulation 2). Each formulation was made by adding the base solvents to a co-solvent in a large glass container and mixing in a 15 wt. % paraffinic wax solution, a cellulose ether thickening agent, sodium lauryl sulfate surfactant, and ethanolamine neutralizer. The 15 wt. % paraffinic wax solution was prepared by adding Sasol Wax (Spray 30-G) from Sasol® Performance Chemicals, Hamburg, Germany to VM&P naptha and stirring at 1,000 RPM for 30-45 minutes until the wax was completely dissolved. The cellulose ether was Methocel™ 311 from ChemPoint, Bellevue, WA. The mixture was stirred with a mechanical stirrer until all components were incorporated into the mixture, and then filtered through a 125-micron paint filter to remove any undissolved particles. In the case of N-butyl caprolactam, after the 15 wt. % paraffinic wax solution and the cellulose ether thickening agent were added, but before the remaining components were added, the formulation was heated to 65° C. for ten minutes, and then cooled to room temperature to build the necessary viscosity profile.

### Example 1—Paint Stripper Effectiveness—Fifteen Minute Residence Time at Room Temperature

Five paint stripper formulations were prepared as described above. Three were based on Formulation 1 and included N-methyl caprolactam, N-ethyl caprolactam or N-methyl pyrrolidine as a co-solvent with the weight percentages of each component shown in Table 1. Two were based on Formulation 2 and included N-methyl caprolactam or N-ethyl caprolactam as a co-solvent with the weight percentages of each component shown in Table 2. The five paint stripper formulations were applied to wood or metal substrates using a solvent-resistant brush, with strokes in one direction from top to bottom. Rust-Oleum® Automotive Stripper and Blue Bear® Paint & Urethane Stripper were also similarly applied to wood or metal substrates for comparison purposes. Rust-Oleum® Automotive Stripper is a highly effective dichloromethane-based stripper. Blue Bear® Paint & Urethane Stripper contains 41% N-methyl pyrrolidone.

TABLE 1

| | Formulation 1 | | |
|---|---|---|---|
| | N-methyl | N-ethyl | N-methyl |
| | caprolactam | caprolactam | pyrrolidone |
| Co-solvent | 46.39% | 46.39% | 46.39% |
| Butyl propionate | 36.08% | 36.08% | 36.08% |
| Ethyl-3-ethoxy propionate | 10.31% | 10.31% | 10.31% |
| Wax solution | 4.64% | 4.64% | 4.64% |
| Cellulose ether | 1.55% | 1.55% | 1.55% |
| Sodium lauryl sulfate | 0.52% | 0.52% | 0.52% |
| Ethanolamine | 0.52% | 0.52% | 0.52% |

TABLE 2

| | Formulation 2 | |
|---|---|---|
| | N-methyl caprolactam | N-ethyl caprolactam |
| Co-solvent | 18.60% | 18.60% |
| Acetone | 27.90% | 27.90% |
| 1,3-Dioxolane | 37.20% | 37.20% |
| Propylene carbonate | 9.30% | 9.30% |
| Wax solution | 4.50% | 4.50% |
| Cellulose ether | 1.50% | 1.50% |
| Sodium lauryl sulfate | 0.50% | 0.50% |
| Ethanolamine | 0.50% | 0.50% |

After fifteen minutes of paint stripper residence time on the substrates at room temperature, the substrates were scraped with a plastic paint scraper and the extent of coating removal for each of the seven paint strippers was evaluated as shown in Table 3, per ASTM D6189:

TABLE 3

| Rating | Amount of Coating Removal |
|---|---|
| 5 | 100% |
| 4 | 75% |
| 3 | 50% |
| 2 | 25% |
| 1 | 10% |
| 0 | None |

The results are shown in Table 4:

TABLE 4

| | SB | SB | WB | WB | WB |
|---|---|---|---|---|---|
| | Alkyd | 2K Epoxy | 2K Epoxy | Acrylic | PUD |
| Formulation 1- | 0 | 3-4 | 0 | 4-5 | 2-3 |
| N-methyl caprolactam | | | | | |
| Formulation 1- | 0 | 3-4 | 0 | 4-5 | 2-3 |
| N-ethyl caprolactam | | | | | |
| Formulation 1- | 0 | 3-4 | 0 | 4-5 | 2-3 |
| N-methyl pyrrolidone | | | | | |
| Formulation 2- | 0 | 1-2 | 0 | 2-3 | 1-2 |
| N-methyl caprolactam | | | | | |
| Formulation 2- | 0 | 1-2 | 0 | 2-3 | 1-2 |
| N-ethyl caprolactam | | | | | |
| Rust-Oleum ® | 4-5 | 4-5 | 4-5 | 4-5 | 4 |
| Automotive Stripper | | | | | |
| Blue Bear ® Paint | 0 | 3-4 | 0 | 4-5 | 2-3 |
| & Urethane Stripper | | | | | |

As shown in Table 4, only the dichloromethane-based commercial stripper was effective against the alkyd and water-borne epoxy coatings. It was also the most effective against all coatings. However, use of dichloromethane-based strippers is generally limited to the severe toxicity concerns of dichloromethane. The formulations based on Formulation 1 were as effective as the N-methyl pyrrolidone-base commercial stripper. The formulations based on Formulation 2 were less effective than those based on Formulation 1. Thus, formulations including N-methyl caprolactam or N-ethyl caprolactam as a co-solvent are as effective in coating removal applications as formulations including N-methyl pyrrolidone as a co-solvent.

### Example 2—Paint Stripper Effectiveness—One Hour Residence Time at Elevated Temperature

Three paint stripper formulations were prepared as described above with the weight percentages of each component shown in Table 5. The three formulations were based on Formulation 1 as described above and included N-methyl caprolactam, N-ethyl caprolactam or N-methyl pyrrolidine as a co-solvent. The three paint stripper formulations were applied to metal substrates with SB Alkyd or WB 2K Epoxy coatings, as described above. These are the two coatings that were not removed at all by the formulations containing N-methyl caprolactam, N-ethyl caprolactam or N-methyl pyrrolidine as a co-solvent after fifteen minutes at room temperature in Example 1.

TABLE 5

| | Formulation 1 | | |
|---|---|---|---|
| | N-methyl | N-ethyl | N-methyl |
| | caprolactam | caprolactam | pyrrolidone |
| Co-solvent | 46.39% | 45.64% | 46.39% |
| Butyl propionate | 36.08% | 35.50% | 36.08% |
| Ethyl-3-ethoxy propionate | 10.31% | 10.14% | 10.31% |
| Wax solution | 4.64% | 4.56% | 4.64% |
| Cellulose ether | 1.55% | 3.15% | 1.55% |
| Sodium lauryl sulfate | 0.52% | 0.51% | 0.52% |
| Ethanolamine | 0.52% | 0.51% | 0.52% |

After fifteen minutes of paint stripper residence time on the substrates an elevated temperature of about 120° F., the substrates were scraped with a plastic paint scraper and the extent of coating removal for each of the three paint strippers was evaluated using the criteria shown in Table 2. If any of the coating remained after fifteen minutes, the coated substrates were again exposed to an elevated temperature of about 120° F. for another fifteen minutes, and again scraped with a plastic paint scraper and the extent of coating removal for each of the paint strippers was evaluated using the criteria shown in Table 3. The process was repeated until the coating was removed from the substrate, or until a total of sixty minutes of residence time had elapsed. The results are shown in Table 6.

TABLE 6

| | SB Alkyd | WB 2K Epoxy |
|---|---|---|
| Formulation 1- | 5 | 0 |
| N-methyl caprolactam | (after 30 minutes) | (after 60 minutes) |
| Formulation 1- | 5 | 0 |
| N-ethyl caprolactam | (after 30 minutes) | (after 60 minutes) |
| Formulation 1- | 5 | 0 |
| N-methyl pyrrolidone | (after 15 minutes) | (after 60 minutes) |

As shown in Table 6, at longer times and higher temperatures, the formulations including N-methyl caprolactam, N-ethyl caprolactam or N-methyl pyrrolidine as a co-solvent are very effective at removing the SB Alkyd coating. The formulation including N-methyl pyrrolidine as a co-solvent removed all of the SB Alkyd coating in fifteen minutes, and the formulations including N-methyl caprolactam or N-ethyl caprolactam as a co-solvent removed all of the SB Alkyd coating in thirty minutes. Base on observation of the wrinkling of the coatings, it appeared that the formulation including the N-methyl caprolactam as a co-solvent was more effective than the formulation including the N-ethyl caprolactam as a co-solvent. None of the three formulations appeared to be effective in removing the WB 2K Epoxy coating, even with a total residence time of one hour at the elevated temperature.

Thus, it is shown that formulations including N-methyl caprolactam or N-ethyl caprolactam have the potential to replace dichloromethane for some coating types, requiring only a somewhat longer residence time and heat.

### Example 3—Paint Stripper Effectiveness—Fifteen Minute Residence Time at Room Temperature-N-Butyl Caprolactam

A paint stripper formulation based on Formulation 1 and including N-butyl caprolactam as a co-solvent was prepared as described above with the weight percentages of each component shown in Table 7. The paint stripper formulation was applied to metal substrates with SB 2K Epoxy or WB Acrylic coatings, and to wood substrates with WB Acrylic or WB PUD coatings, as described above. These are the three coatings that were at least partially removed by the formulations containing N-methyl caprolactam, N-ethyl caprolactam or N-methyl pyrrolidine as a co-solvent after fifteen minutes at room temperature in Example 1.

TABLE 7

| | Formulation 1 |
|---|---|
| | N-butyl caprolactam |
| Co-solvent | 48.54% |
| Butyl propionate | 37.75% |
| Ethyl-3-ethoxy propionate | 10.79% |
| Wax solution | 1.39% |
| Cellulose ether | 0.46% |
| Sodium lauryl sulfate | 0.54% |
| Ethanolamine | 0.54% |

After fifteen minutes of paint stripper residence time on the substrates at room temperature, the substrates were scraped with a plastic paint scraper and the extent of coating removal was evaluated as shown in Table 2, per ASTM D6189. The results are show in Table 8:

TABLE 8

| | SB | WB | WB |
|---|---|---|---|
| | 2K Epoxy | Acrylic | PUD |
| Formulation 1-N-butyl caprolactam | 1-2 | 4-5 | 2-3 |

As shown in Table 8 and Table 4, the formulation including N-butyl caprolactam as a co-solvent was about as effective in removing WB Acrylic and WB PUD coatings as formulations including N-methyl caprolactam, N-ethyl caprolactam or N-methyl pyrrolidine as a co-solvent. The formulation including N-butyl caprolactam as a co-solvent was slightly less effective in removing the SB 2K Epoxy coating than formulations including N-methyl caprolactam, N-ethyl caprolactam or N-methyl pyrrolidine as a co-solvent. Thus, formulations including N-methyl caprolactam, N-ethyl caprolactam or N-butyl caprolactam as a co-solvent confer similar paint stripping properties as N-methyl pyrrolidone.

What is claimed is:

1. A method for removing cured, partially cured, or uncured paints from painting equipment comprising:
applying a cleaning composition to a portion of the painting equipment having a metal surface and containing the cured, partially cured, or uncured paint to dissolve the paint wherein:
the cleaning composition comprises a primary solvent and a co-solvent, the co-solvent including N-ethylcaprolactam present in an amount from 5 wt. % to 49 wt. % of the total weight of the cleaning composition, and
the paint selected from alkyd paints, epoxy paints, acrylic paints, polyurethane paints, and combinations of the foregoing; and
removing the cleaning composition including the dissolved paint from the metal surface of the painting equipment.

2. The method of claim 1, wherein the primary solvent is selected from alkyl lactates, esters, lactones, dioxolanes, glycols, glycol ethers, glycol ether acetates, ether esters, dialkyl carbonates, alkylene carbonates, alkoxyalcohols, and diabasic esters, ketones water, or any combination thereof.

3. The method of claim 1, wherein the primary solvent is selected from butyl propionate, ethyl-3-ethoxypropionate, acetone, 1,3-dioxolane, propylene carbonate, cyclohexanone, water, or combinations of the foregoing.

4. The method of claim 1, wherein the primary solvent comprises toluene.

5. The method of claim 1, wherein the cleaning composition further comprises a surfactant.

6. The method of claim 5, wherein the surfactant is selected from ethoxylated glyceryl fatty acid esters; sorbitan esters; ethoxylated sorbitan esters; glycerol mono/dioleate; PEG alkoxylated block polymers; alkoxylated alcohols; alkoxylated alkylphenols; alkoxylated amines; alkoxylated amides; alkoxylated fatty esters; alkoxylated oils; fatty esters; alkoxylated fatty acids; sorbitan derivatives; alkylaryl sulfonates; alkylaryl sulfonic acids; carboxylated alcohol ethoxylates; alkylphenol ethoxylates; carboxylic acids; diphenyl sulfonate derivatives; olefin sulfonates; phosphate esters; phosphorous organic derivatives; anionic surfactants; and quaternary surfactants, or combinations of the foregoing.

7. The method of claim 5, wherein the surfactant is present in an amount from 0.1 wt. % to 2.0 wt. % based upon the total weight of the cleaning composition.

8. The method of claim 1, wherein the cleaning composition further including a thickening agent.

9. The method of claim 5, wherein the thickening agent is selected from organoclays; fatty acid salts; fumed silica; paraffinic waxes; alkylated cellulose derivatives; esterified cellulose derivatives; or oxyalkylated cellulose derivatives or combinations thereof.

10. The method of claim 5, wherein the thickening agent is present in an amount from 0.1 wt. % to 2.0 wt. % based upon the total weight of the cleaning composition.

11. The method of claim 5, wherein the painting equipment comprises a paint spray gun.

12. The method of claim 11, wherein the paint spray gun is a high-volume low-pressure (HVLP) spray gun.

13. The method of claim 11, further comprising maintaining the cleaning composition in contact within the paint spray gun for 30 minutes or more at room temperature.
